(19) United States
(12) Patent Application Publication
(10) Pub. No.: US 2025/0355287 A1
(43) Pub. Date: Nov. 20, 2025

(54) MULTI-DOMAIN LITHIUM NIOBATE CRYSTALS AND SEE-THROUGH NEAR-EYE DISPLAY DEVICES

(71) Applicant: II-VI Delaware, Inc., Wilmington, DE (US)

(72) Inventors: Daniel Rytz, Wilmington, DE (US); Michael Scripsick, Wilmington, DE (US); Dimitar Shumov, Wilmington, DE (US)

(21) Appl. No.: 19/175,686

(22) Filed: Apr. 10, 2025

Related U.S. Application Data
(60) Provisional application No. 63/647,393, filed on May 14, 2024.

(51) Int. Cl. G02F 1/035; G02B 27/01

(52) U.S. Cl. CPC G02F 1/035; G02B 27/0172; G02F 2202/20

(57) ABSTRACT

A see-through near-eye display device guides virtual-image light in a one-dimensional waveguide composed of a multi-domain lithium niobate crystal containing a plurality of ferroelectric domains. Each ferroelectric domain is polarized along a z-axis of the lithium niobate crystal and has a polarization direction opposite the polarization direction of an adjacent ferroelectric domain. The high refractive index of lithium niobate enables displaying large-FOV virtual imagery. The multi-domain structure prevents undesirable charge buildup associated with the ferroelectric and pyroelectric properties of a single-domain lithium niobate waveguide. Multi-domain lithium niobate crystals may be produced by (a) cooling a lithium niobate crystal boule, or crystal cut therefrom, through the Curie temperature in an isothermal environment with no active poling, or (b) cooling an x- or y-axis grown lithium niobate crystal, or crystal cut therefrom, through the Curie temperature in a temperature gradient that is orthogonal to the z-axis with no active poling.

### CROSS REFERENCE TO RELATED APPLICATIONS

This application claims priority to and the benefit of U.S. Provisional Patent Application No. 63/647,393 entitled “MULTI-DOMAIN LITHIUM NIOBATE CRYSTALS AND SEE-THROUGH NEAR-EYE DISPLAY DEVICES” filed May 14, 2024, which is hereby incorporated herein by reference in its entirety.

### BACKGROUND

Limitations and disadvantages of traditional augmented reality (AR) glasses will become apparent to one of skill in the art, through comparison of such approaches with some aspects of the present method and system set forth in the remainder of this disclosure with reference to the drawings.

### BRIEF SUMMARY

Systems and methods are provided for the manufacture of waveguides capable of relaying large-field-of-view virtual content into a user's field of view, substantially as illustrated by and/or described in connection with at least one of the figures, as set forth more completely in the claims.

### BRIEF DESCRIPTION OF THE DRAWINGS

The accompanying drawings, which are incorporated in and constitute a part of the specification, schematically illustrate embodiments of the present disclosure, and together with the general description given above and the detailed description of the embodiments given below, serve to explain principles of the present disclosure.

FIG. 1 illustrates a pair of AR glasses including left and right see-through near-eye display devices, each based on a one-dimensional waveguide made of a multi-domain lithium niobate, according to an embodiment.

FIG. 2 schematically illustrates exemplary light propagation in a see-through near-eye display device based on a multi-domain lithium niobate waveguide, according to an embodiment.

FIG. 3 is a schematic magnified view of a portion of a z-cut, planar, multi-domain lithium niobate waveguide, according to an embodiment. The multi-domain structure is promoted during a cooling through the Curie temperature.

FIG. 4 is a schematic magnified view of a portion of a x- or y-cut, planar, multi-domain lithium niobate waveguide, according to an embodiment. The multi-domain structure is promoted during a cooling through the Curie temperature.

FIG. 5 is a magnified view of a z-cut, planar, multi-domain lithium niobate waveguide with actively poled ferroelectric domains, according to an embodiment.

FIG. 6 is a magnified view of another z-cut, planar, multi-domain lithium niobate waveguide with actively poled ferroelectric domains, according to an embodiment.

FIG. 7 is a flowchart for a method for manufacturing a multi-domain lithium niobate crystal boule, wherein the multi-domain structure is promoted during cooling of the lithium niobate crystal boule in an isothermal environment, according to an embodiment.

FIG. 8 illustrates an embodiment of a crystal growth step of the FIG. 7 method utilizing the Czochralski growth process.

FIG. 9 is a schematic cross section of an exemplary crystal boule produced in the crystal growth step of the FIG. 7 method.

FIG. 10 illustrates an embodiment of an isothermal cooling step of the FIG. 7 method, wherein isothermal cooling is performed in the same furnace as crystal growth.

FIG. 11 is a plot of exemplary temperature profiles during crystal growth and isothermal cooling in the FIG. 7 method.

FIG. 12 illustrates one example of a cutting step of the FIG. 7 method, wherein a crystal boule is cut orthogonally to its growth direction to produce a plurality of multi-domain lithium niobate wafers.

FIG. 13 is a flowchart for manufacturing a multi-domain lithium niobate crystal. The lithium niobate crystal is cut from a lithium niobate crystal boule, and the multi-domain structure is promoted during cooling of the lithium niobate crystal in an isothermal environment, according to an embodiment.

FIG. 14 illustrates an example of a cutting step of the FIG. 13 method, wherein a crystal boule is cut along two cutting lines, orthogonally to the growth axis of the crystal boule, to produce a smaller crystal.

FIG. 15 is a flowchart for a method for manufacturing a multi-domain lithium niobate crystal boule, wherein the crystal boule is x- or y-axis grown and multi-domain structure is promoted during cooling of the lithium niobate crystal boule in the growth furnace in a temperature gradient that is aligned with the growth axis, according to an embodiment.

FIG. 16 illustrates an embodiment of a crystal growth step of the FIG. 15 method utilizing the Czochralski growth process.

FIG. 17 illustrates an embodiment of a gradient cooling step of the FIG. 15 method.

FIG. 18 is a plot of exemplary temperature profiles during the crystal growth and gradient cooling steps of the FIG. 15 method.

FIG. 19 is a schematic diagram of an exemplary crystal boule produced in the FIG. 15 method showing exemplary isotherms during the gradient cooling step.

FIG. 20 is a schematic diagram of the crystal boule related to the FIG. 19 diagram showing exemplary horizontal slices of the crystal boule undergoing the phase transition.

FIG. 21 is a schematic diagram of the crystal boule related to the FIG. 19 diagram showing an exemplary non-planar isotherm.

FIG. 22 is a flowchart for a method for manufacturing a multi-domain lithium niobate crystal boule, wherein the crystal boule is x- or y-axis grown and multi-domain structure is promoted during cooling of the lithium niobate crystal boule in a temperature gradient that is orthogonal to the z-axis, according to an embodiment.

FIG. 23 illustrates a crystal growth furnace configured to electrically manipulate an x-axis grown crystal boule during the cooling process that promotes the multi-domain configuration in the FIG. 15 method, according to an embodiment.

FIG. 24 is a flowchart for a method for manufacturing a see-through near-eye display device with a multi-domain lithium niobate waveguide, according to an embodiment.

### DETAILED DESCRIPTION

The following discussion provides various examples. Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

The present disclosure relates to see-through near-eye display devices used in augmented reality (AR) glasses. In particular, the present disclosure relates to the manufacture of waveguides capable of relaying large-field-of-view virtual content into a user's field of view.

AR glasses superimpose electronically-generated virtual content on a real scene viewed by the user, thereby creating a hybrid visual experience containing both a real-scene image and a virtual image. Superimposing the virtual content on the real-scene image entails merging light conveying the virtual content into the path of the light from the real scene. For wide-spread user adoption, it is preferable that the user's view and perception of the real scene is augmented without being compromised. Widespread user adoption also requires that the AR glasses are aesthetically pleasing and, for example, look like regular eyeglasses. Furthermore, an immersive experience is desired, wherein the virtual image can be overlaid on a large portion of the user's FOV.

A pair of AR glasses includes one or two see-through near-eye display devices, one device for each eye or just a single device for either the left or the right eye. At a basic level, the see-through near-eye display device includes (a) a virtual-image source that emits light conveying the virtual image, and (b) relay-and-combination optics that relay the virtual-image-light into the user's FOV and deflect the virtual-image-light into the path of light propagating from the real scene toward the eye. Designing non-bulky relay-and-combination optics capable of creating large-FOV virtual images of high quality and with minimal degradation of the real-scene image is a challenging task critical to the user experience. One early-generation type of AR glasses suspended a prism in a corner of the user's FOV to deflect light from a digital display device toward the user's eye. The result was a virtual image overlayed on the real-scene image in a relatively peripheral location. The functionality was limited, and this type of AR glasses was not a commercial success.

Lithium niobate is a crystalline material with a high refractive index and high transparency in the visible spectrum. Single lithium niobate crystals are generally grown by the Czochralski method: A seed crystal is held in a melt and pulled upwards from the melt while the material of the melt solidifies on the seed crystal, resulting in ongoing crystal growth. Depending on, e.g., the composition of the melt, different forms of lithium niobate single-crystals may be formed, including congruent lithium niobate (cLiNbO3), stoichiometric lithium niobate (sLiNbO3), and doped LiNbO3 such as magnesium-doped lithium niobate (Mg:LiNbO3) or zinc-doped lithium niobate (Zn:LiNbO3). Depending on, e.g., the exact crystalline form as well as the temperature, the refractive index of lithium niobate is typically at least 2.15 throughout the visible spectrum.

Lithium niobate crystals exhibit trigonal symmetry, with different properties along three mutually orthogonal crystal axes, x, y, and z, respectively. The thermal expansion rates along the x- and y-axes are similar to each other but significantly different from the thermal expansion rate along the z-axis. This has implications for the growth process. The Czochralski growth method exposes the growing crystal to a vertical temperature gradient, but it is possible to maintain a relatively uniform temperature in each horizontal plane. Lithium niobate crystals are most commonly grown along the z-axis (that is, with the z-axis being vertical) because the crystal is then less likely to crack while growing and during subsequent cool down. Lithium niobate crystals may also be grown along the x- or y-axis, although this either limits the achievable crystal size or requires special attention to the issue of thermal expansion.

Lithium niobate crystals are ferroelectric. The ferroelectric domains are polarized along the z-axis in the positive or negative z-axis direction. Lithium niobate crystals also exhibit substantial pyroelectricity, that is, the magnitude of polarization is temperature sensitive. In most applications of lithium niobate crystals, the lithium niobate crystal must be composed of a single ferroelectric domain. For this purpose, a poling procedure is applied. Typically, the poling procedure entails subjecting the entire lithium niobate crystal boule to an electric field, aligned with the z-axis, while the crystal cools to below the Curie temperature.

Waveguide-based see-through near-eye display devices are becoming a leading technology for providing a more immersive experience with improved see-through performance and packaging akin regular eyeglasses. In these waveguide-based devices, a one-dimensional waveguide relays the virtual-image-light into the user's field of view (FOV), and a grating disposed on the waveguide couples the virtual-image-light out of the waveguide toward the user's eye. The waveguide can be identical in shape to the lens of a regular pair of eyeglasses having zero optical power, and the virtual-image source can be integrated in the arm of the glasses. Waveguiding is based on total internal reflection. The waveguide material can therefore be transmissive to visible light from the real scene while functioning as a light conduit for visible light from the virtual-image source.

Disclosed herein are waveguide-based see-through near-eye display devices that use multi-domain lithium niobate as the waveguide material. Lithium niobate with multiple ferroelectric domains, typically many, is an advantageous material choice for the waveguide in waveguide-based see-through near-eye display devices. When a waveguide is used to relay the virtual content, the FOV spanned by the virtual content is limited by the range of propagation angles guided in the waveguide by the mechanism of total internal reflection. In turn, the range of guided propagation angles is limited by the refractive index contrast at the surfaces of the waveguide. The high refractive index of lithium niobate allows for relaying large-FOV virtual content to the user, and its crystalline nature ensures high optical quality of both the real-scene image and the virtual image. The multi-domain structure of the present lithium niobate waveguides prevents undesirable charge buildup associated with the ferroelectric and, in particular, pyroelectric properties of a single-domain lithium niobate waveguide. For example, if a pair of AR glasses with a single-domain lithium niobate waveguide were left in the sun, a user could get an electric shock from the pyroelectrically induced charge buildup.

Conventionally grown and processed lithium niobate crystals do not exhibit the multi-domain structure used for the present waveguides. Thus, also disclosed herein are methods for manufacturing multi-domain lithium niobate crystals. The presently disclosed methods include a method that grows the lithium niobate crystal boule along the z-axis, as well as methods that grow the lithium niobate crystal boule along the x- or y-axis. The multi-domain structure may be promoted by cooling the lithium niobate crystal boule, or a crystal cut therefrom, from above to below the Curie temperature in a specifically tailored thermal environment.

In one aspect of the disclosure, a see-through near-eye display device includes an image source, a one-dimensional waveguide, and a grating. The image source is configured to emit light conveying an image. The one-dimensional waveguide is composed of a multi-domain lithium niobate crystal and arranged to receive and guide the light emitted by the image source. The multi-domain lithium niobate crystal contains a plurality of ferroelectric domains. Each ferroelectric domain is polarized along a z-axis of the lithium niobate crystal and has a polarization direction opposite the polarization direction of an adjacent ferroelectric domain. The multi-domain lithium niobate crystal is a single crystal. The grating is disposed on or in the waveguide. The grating is configured to couple out of the waveguide at least a portion of the light from the image source after having been guided by the waveguide to the grating.

In another aspect of the disclosure, a method for manufacturing a multi-domain lithium niobate crystal includes growing a lithium niobate crystal boule from a melt in a furnace having a temperature gradient. The method further includes, in an isothermal environment, cooling a lithium niobate crystal, in the form of the lithium niobate crystal boule or a smaller crystal cut therefrom, from above to below a Curie temperature of the lithium niobate crystal to form multiple ferroelectric domains. Each ferroelectric domain is polarized along the z-axis and has a polarization direction opposite the polarization direction of an adjacent ferroelectric domain.

In yet another aspect of the disclosure, a method for manufacturing a multi-domain lithium niobate crystal includes growing a lithium niobate crystal boule from a melt in a furnace having a first temperature gradient. An x- or y-axis of the lithium niobate crystal boule is aligned with the temperature gradient. The method further includes cooling a lithium niobate crystal, in the form of the lithium niobate crystal boule or a smaller crystal cut therefrom, from above to below a Curie temperature of the lithium niobate crystal in an environment characterized by a second temperature gradient orthogonal to a z-axis of the lithium niobate crystal boule, or smaller crystal, so as to form multiple ferroelectric domains. Each ferroelectric domain is polarized along the z-axis of the lithium niobate crystal boule or smaller crystal and has a polarization direction opposite the polarization direction of an adjacent ferroelectric domain.

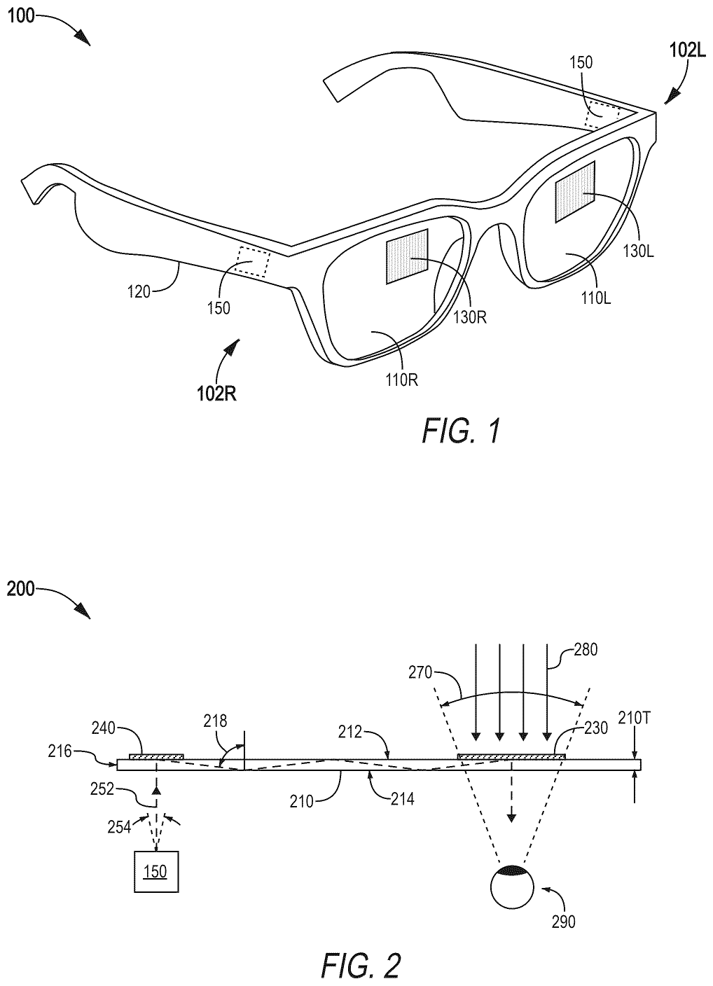

Referring now to the drawings, wherein like components are designated by like numerals, FIG. 1 illustrates one pair of AR glasses 100 including a left see-through near-eye display device 102L and a right see-through near-eye display device 102R, each based on a one-dimensional waveguide made of a single multi-domain lithium niobate crystal. Each of display devices 102L and 102R includes a multi-domain lithium niobate waveguide 110, a grating 130, and a virtual-image source 150. Virtual-image sources 150 may be integrated in a frame 120 of AR glasses 100. Each virtual-image source 150 emits virtual-image light conveying a virtual image to be formed in an eye of the user. For this purpose, each virtual-image source 150 may include (a) a digital display configured with a collimation lens or (b) a scanning laser projector.

Waveguides 110 are incorporated into AR glasses 100 in the form of the left and right “lenses” thereof. Typically, the “lenses” formed by waveguides 110 have zero optical power. In this case, each waveguide 110 may be a planar waveguide with two parallel planar surfaces. However, without departing from the scope hereof, one or both of waveguides 110 may be curved and even have non-zero optical power, for example according to a user's ophthalmic prescription. Each waveguide 110 is a one-dimensional waveguide that confines guided light in one transverse dimension.

In operation, a user views a real scene through AR glasses 100, that is, through the “lenses” formed by waveguides 110. More specifically, light from a real scene is transmitted by gratings 130 and waveguides 110, without being guided by waveguides 110. One or both of display devices 102L and 102R superimposes a virtual image on the real scene viewed by the user through AR glasses 100. In each of display devices 102L and 102R, this process entails light emitted by virtual-image source 150 being coupled into waveguide 110. Coupling of such virtual-image light into waveguide 110 may take place outside the user's FOV and/or in a location hidden by frame 120. Waveguide 110 then guides the virtual-image light to the location of grating 130. Grating 130 is disposed on or in waveguide 110. Grating 130 diffracts at least a portion of the virtual-image light out of waveguide 110 in the direction toward the user's eye, whereby a virtual image originating from virtual-image source 150 is superimposed on the real-scene image viewed by the user.

FIG. 2 schematically illustrates, in cross-sectional view, exemplary light propagation in one see-through near-eye display device 200 based on a multi-domain lithium niobate waveguide. Display device 200 may be implemented in AR glasses 100 as either one of display devices 102L and 102R. Alternatively, display device 200 may be implemented as part of a conventional eye-glasses lens, or otherwise positioned in a user's field of view. Display device 200 includes a planar multi-domain lithium niobate waveguide 210, gratings 230 and 240, and virtual-image source 150.

Waveguide 210 is depicted as a planar waveguide having two planar surfaces 212 and 214. Alternatively, one or both of surfaces 212 and 214 may have some curvature. Surfaces 212 and 214 cooperate to impose one-dimensional waveguiding through the mechanism of total internal reflection. The thickness 210T of waveguide 110 between surfaces 112 and 114 is, for example, in the range between 0.5 and 2 millimeters (mm). In one embodiment, waveguide 210 is a single lithium niobate crystal.

Each of gratings 230 and 240 may be a surface relief grating or a holographic grating. Gratings 240 and 230 are a non-zero distance, e.g., between 10 and 50 mm, apart from each other. FIG. 2 depicts an example where gratings 230 and 240 are located at surface 212 of waveguide 210, that is, at the surface of waveguide 210 facing away from a user's eye 290. Alternatively, one or both of gratings 230 and 240 may be located at surface 214 or embedded in waveguide 210. In the depicted embodiment, virtual-image source 150 is on the same side of waveguide 210 as eye 290. Alternatively, although typically not advantageous for packaging purposes, virtual-image source 150 may be on the opposite side of waveguide 210 than eye 290.

In operation, grating 240 diffracts virtual-image light 252 from virtual-image source 150 into waveguide 210, whereafter waveguide 210 guides this virtual-image light 252 in the direction toward grating 230. Grating 230 then diffracts at least a portion of the guided virtual-image light 252 toward eye 290. Diffraction of the guided virtual-image light 252 toward eye 290 superimposes virtual-image light 252 on light 280 propagating toward eye 290 from a real scene. Without departing from the scope hereof, grating 240 may be omitted, in which case virtual-image light 252 may instead be coupled into waveguide 210 via an end surface 216 of waveguide 210.

Virtual-image source 150 emits virtual-image light 252 with a range 254 of propagation angles. When display device 200 relays virtual-image light 252 to eye 290, focusing of virtual-image light 252 by eye 290 maps each of these propagation angles to a respective location on the retina of eye 290. In other words, image information is encoded in the propagation angles of the light emitted by virtual-image source 150. The achievable FOV 270 spanned by virtual-image light 252 is defined by the range of propagation angles of virtual-image light 252 from waveguide 210 toward eye 290. However, FOV 270 is limited by the range of propagation angles that can be guided by waveguide 210.

FIG. 2 indicates the propagation of a central ray of virtual-image light 252. More generally, each propagation angle of virtual-image light 252 corresponds to a respective internal incidence angle 218 on surfaces 212 and 214 of waveguide 210. Rays are guided by waveguide 210 only when incidence angle 218 is in the range between 90 degrees and the critical angle θ_c for total internal reflection. Achieving a large FOV 270 may require that critical angle θ_c be small. Critical angle θ_c is defined by the refractive index contrast between waveguide 210 and the surrounding medium through the relationship θ_c=“arcsin” (n_2/n_1), wherein n_1 and n_2 are the respective refractive indices of waveguide 210 and the surrounding medium, typically air. The high refractive index of lithium niobate results in a small critical angle θ_c and thus a large achievable FOV 270. Therefore, as compared to more conventional materials having a lower refractive index, the present choice of lithium niobate as the waveguide material enables a more immersive experience for the user.

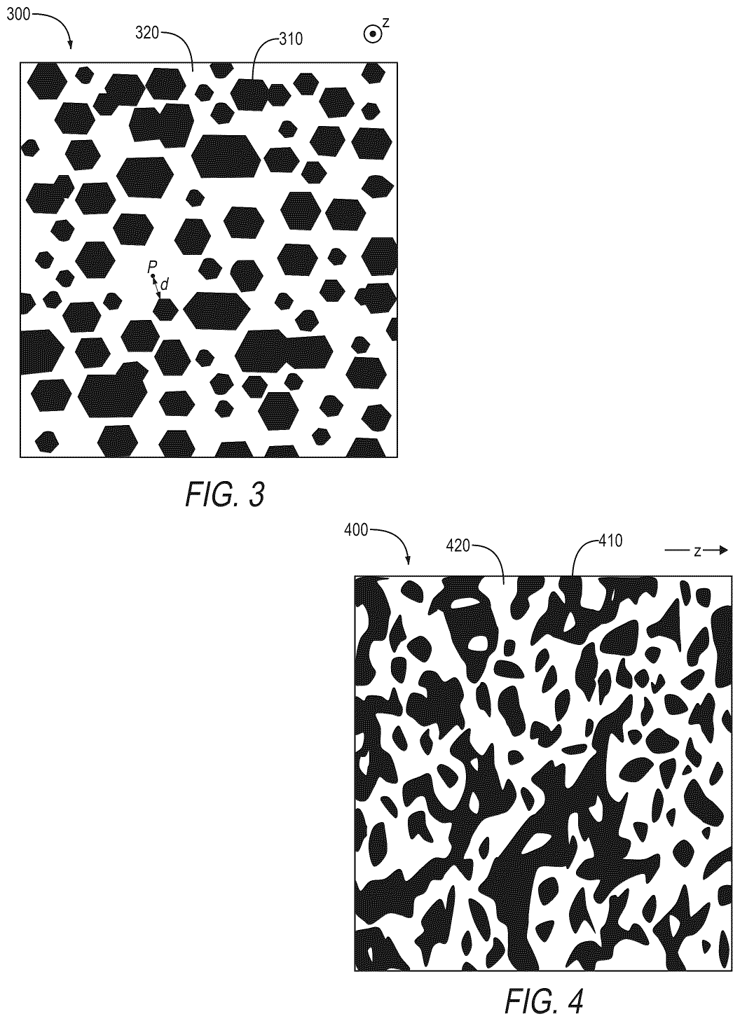

The lithium niobate crystal of waveguide 210 has multiple ferroelectric domains. The multiple ferroelectric domains prevent pyroelectric effects that are undesirable in the use of waveguide 210 in display device 200. The ferroelectric domains of waveguide 210 may be configured in many ways. A few select embodiments of waveguide 210 with different respective domain configurations are depicted in FIGS. 3-6.

FIG. 3 is a schematic magnified view of a portion of one z-cut, planar, multi-domain lithium niobate waveguide 300. The z-axis of the lithium niobate crystal is orthogonal to the plane of waveguide 300. Herein, any mention of x-, y-, and z-axes refers to the crystal axes of lithium niobate. Ferroelectric domains 310 (black) and 320 (white) of waveguide 300 have opposite polarizations. Each individual ferroelectric domain may span between the two waveguiding surfaces of waveguide 300 (surfaces 212 and 214 in FIG. 2). In the depicted example of waveguide 300, many separate ferroelectric domains 310 are situated in a larger, connected ferroelectric domain 320. Alternatively, waveguide 300 may include multiple separate ferroelectric domains 320 as well. The number of ferroelectric domains 320 may be similar to the number of ferroelectric domains 310. Whether or not ferroelectric domains 310 and 320 are present in similar numbers, the prevalence of ferroelectric domains 310 and 320 may be relatively equal in terms of volume. For example, the ratio between the respective volumes occupied by ferroelectric domains 310 and 320 may be approximately 50%/50%, e.g., in the range between 33%/67% and 67%/33%.

In order to help prevent undesirable charge buildup on the waveguiding surfaces (surfaces 212 and 214 in FIG. 2), the shortest distance d, parallel to waveguide 300, from any given point P to a ferroelectric domain of the opposite polarization may, at least on average, be less than 500 micrometers (μm). For example, distance d may, on average, be in the range between 0.3 and 150 μm. At least when the prevalence of ferroelectric domains 310 and 320 per volume is relatively equal, the multi-domain configuration of waveguide 300 prevents a significant net-charge buildup on either one of the two waveguiding surfaces. Additionally, when distance d is small, e.g., less than 500 μm on average, charge diffusion may reduce charge buildup in any local areas of the waveguiding surfaces, even when the respective prevalences of ferroelectric domains 310 and 320 per volume are dissimilar.

FIG. 4 is a schematic magnified view of a portion of one x- or y-cut, planar, multi-domain lithium niobate waveguide 400. The z-axis of the lithium niobate crystal is parallel to the plane of waveguide 400. Ferroelectric domains 410 (black) and 420 (white) of waveguide 400 have opposite polarizations. Whereas the polarizations of ferroelectric domains 310 and 320 of waveguide 300 are orthogonal to waveguide 300, the polarizations of ferroelectric domains 410 and 420 of waveguide 400 are parallel to waveguide 400.

Before discussing the multi-domain configuration of waveguide 400, consider an x- or y-cut, planar, single-domain waveguide. The single ferroelectric domain of such as waveguide is polarized along the plane of the waveguide. Therefore, charge buildup on waveguide 400 caused by the pyroelectric effect will, at least primarily, be on surfaces that connect between the waveguiding surfaces of waveguide 400, e.g., on end surface 216 shown in FIG. 2. It may be possible to outfit these surfaces with discharging electrodes without obscuring the user's view of either one of the real scene and the virtual imagery. However, the addition of discharging electrodes may be deemed an undesirable complication. Furthermore, in embodiments of display device 200 where virtual-image light 252 is coupled into waveguide 210 via end surface 216, such electrodes may interfere with virtual-image light 252.

Referring now to waveguide 400, the multi-domain structure of waveguide 400 is similar to waveguide 300 except that (a) the polarization of ferroelectric domains 410 and 420 is parallel to waveguide 400 and (b) the shapes of ferroelectric domains 410 and 420 may be different from the shapes of ferroelectric domains 310 and 320. For example, ferroelectric domains 310 and/or 320 may be hexagonal (as shown in FIG. 3), whereas ferroelectric domains 410 and 420 typically are not hexagonal in the FIG. 3 cross section.

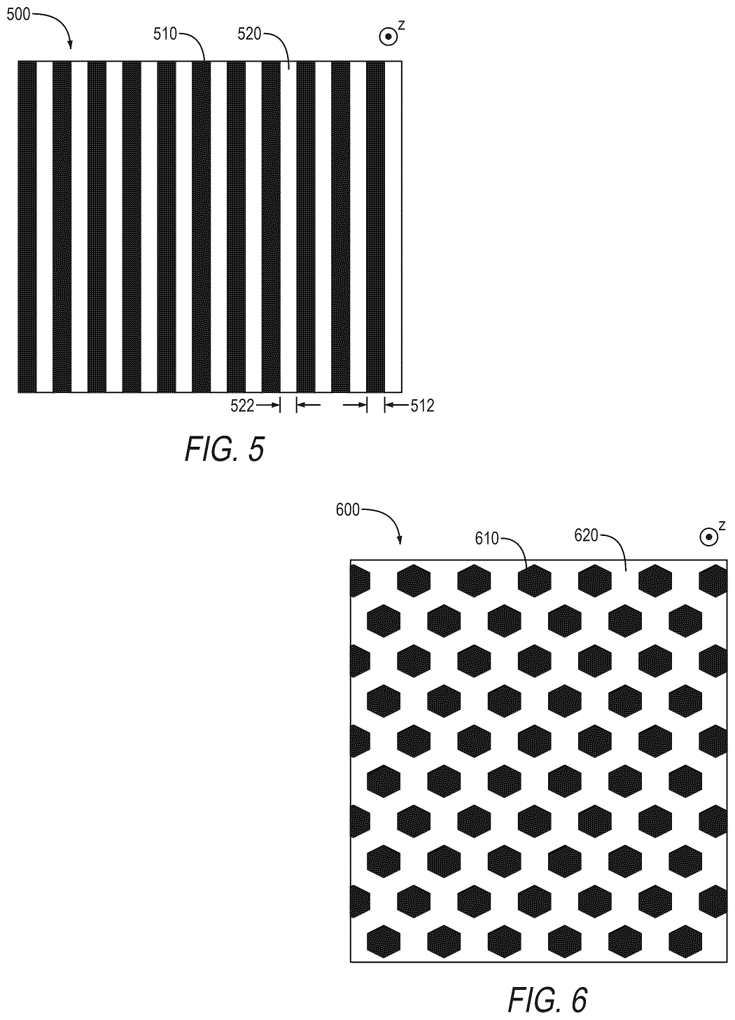

The ferroelectric domains of each of waveguides 300 and 400 may be randomly distributed, as depicted in FIGS. 3 and 4. The formation of randomly distributed ferroelectric domains may be promoted during cooling of a lithium niobate crystal from above to below the Curie temperature. In contrast, FIGS. 5 and 6 show examples of domain configurations produced by actively poling a lithium niobate waveguide, substrate, or wafer. These domain configurations may be produced using active poling techniques similar to those used to make periodically-poled frequency conversion crystals.

FIG. 5 is a magnified view of one z-cut, planar, multi-domain lithium niobate waveguide 500 with actively poled ferroelectric domains. Ferroelectric domains 510 (black) and 520 (white) of waveguide 500 have opposite polarizations. Each individual ferroelectric domain may span between the two waveguiding surfaces of waveguide 500 (surfaces 212 and 214 in FIG. 2). Ferroelectric domains 510 and 520 are arranged in a one-dimensional alternating pattern. This pattern may be a repeating, periodic pattern (as shown). The respective widths 512 and 522 of ferroelectric domains 510 and 520 may be similar in order to achieve approximately equal prevalence of ferroelectric domains 510 and 520 in terms of volume, as discussed above for waveguide 300. Widths 512 and 522 may be sized such that the average shortest distance d, parallel to waveguide 500, from any given point P to a ferroelectric domain of the opposite polarization is similar to that discussed for waveguide 300.

FIG. 6 is a magnified view of another z-cut, planar, multi-domain lithium niobate waveguide 600 with actively poled ferroelectric domains. Ferroelectric domains 610 (black) and 620 (white) of waveguide 600 have opposite polarizations. The domain configuration of ferroelectric domains 610 and 620 is similar to that of ferroelectric domains 510 and 520 of waveguide 500 except that ferroelectric domains 610 and 620 are arranged in a two-dimensional pattern.

While each of FIGS. 3-6 show and discuss a planar waveguide, each of these waveguides may be polished or otherwise machined to produce a non-planar waveguide, while retaining the depicted multi-domain structure. It is also possible to form the ferroelectric domains after such polishing or machining and achieve multi-domain structures similar to those depicted. In addition, while the waveguides of FIGS. 5 and 6 each have many ferroelectric domains, it is possible (but not necessarily advantageous) to actively pole a lithium niobate with only two oppositely-polarized domains while maintaining the same average shortest distance d as discussed above. For example, two interleaved spiral-shaped domains may suffice.

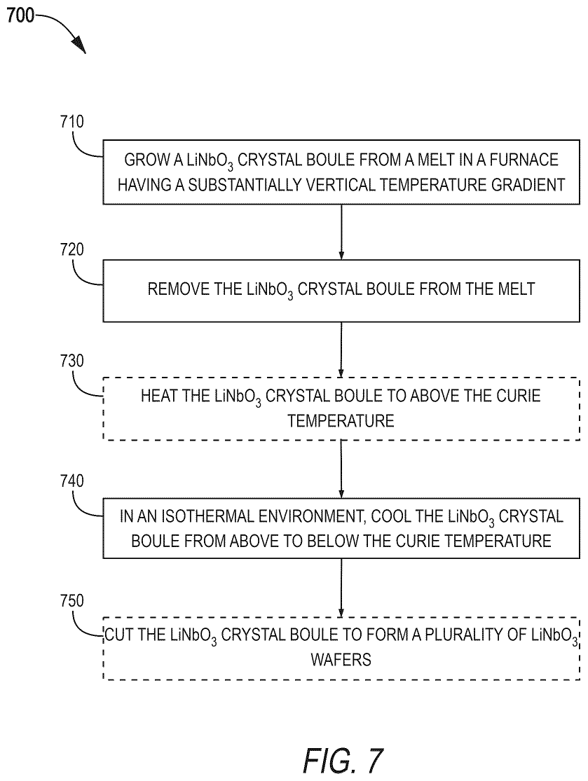

FIG. 7 is a flowchart for one method 700 for manufacturing a multi-domain lithium niobate crystal boule, wherein the multi-domain structure is promoted during cooling of the lithium niobate crystal boule in an isothermal environment. The multi-domain lithium niobate crystal boule manufactured by method 700 may be cut and/or otherwise machined to produce certain embodiments of waveguide 210 of display device 200, for example either one of waveguides 300 and 400.

Method 700 grows a lithium niobate crystal boule from a melt in a furnace (step 710). The growth process utilizes a temperature gradient, wherein the temperature decreases as a function of distance above the melt. In order to contain the melt, it is most practical that the temperature gradient is substantially vertical, for example within 30 degrees of vertical or more preferably within 15 degrees. After removing the crystal boule from the melt (step 720), method 700 cools the crystal boule from above to below the Curie temperature in an isothermal environment (step 740) in order to promote many ferroelectric domains in the crystal boule. The type of lithium niobate crystal formed in crystal growth step 710 depends on, e.g., the composition of the melt. Types of crystals that can be grown include cLiNbO3, sLiNbO3, and doped crystals such as Mg:LiNbO3 or Zn:LiNbO3.

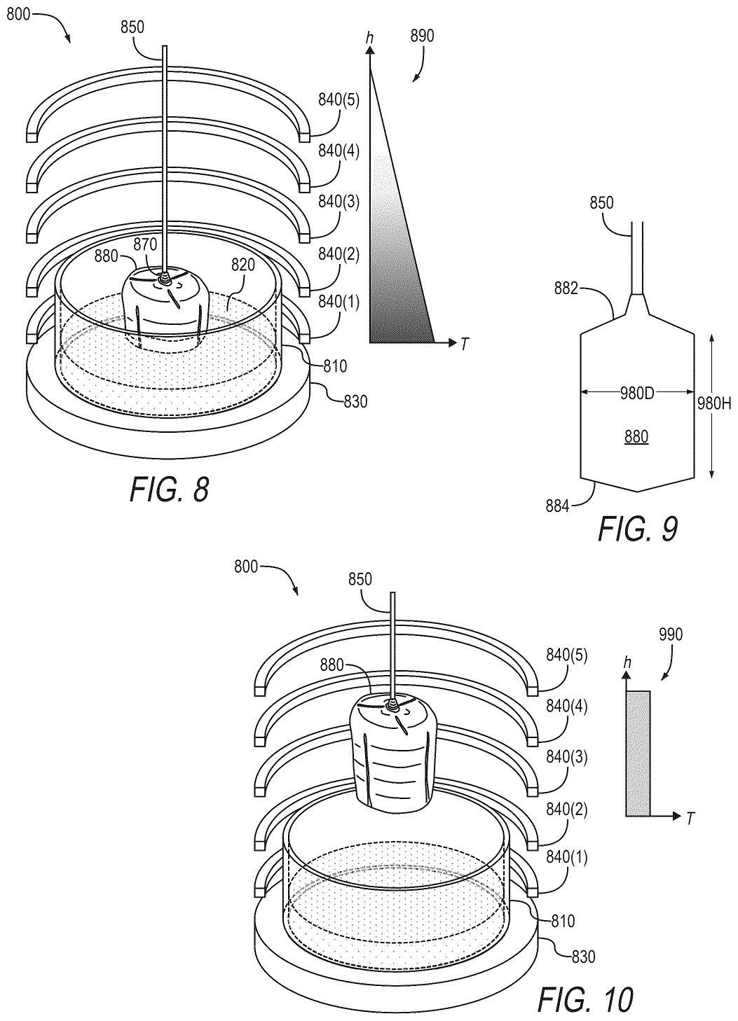

FIG. 8 illustrates one embodiment of crystal growth step 710 of method 700 utilizing the Czochralski growth process. In this embodiment, a lithium niobate crystal boule 880 is grown from a melt 820 in a furnace 800. Melt 820 is contained by a crucible 810 that may rest on a base 830. Base 830 may be heated. Furnace 800 is equipped with a series of heating elements 840 distributed vertically. Each heating element 840 may be resistive or inductive. For crystal growth step 710, heating elements 840 are adjusted to generate a vertical temperature gradient 890. In the schematic depiction in FIG. 8, vertical temperature gradient 890 is linear. However, vertical temperature gradient 890 may deviate from linearity. The average vertical temperature gradient 890 may be in the range between 8 and 60 degrees Celsius per centimeter. Growth of crystal boule 880 is initiated at a seed crystal 870 attached to a rod (or other fixture) 850. Rod 850 is rotated and raised gradually to facilitate continued growth of crystal boule 880 at the crystal-to-melt interface.

FIG. 9 is a schematic cross section of an exemplary crystal boule 880 produced in crystal growth step 710 of method 700. The cross section includes the growth axis of crystal boule 880. Crystal boule 880 may be roughly cylindrical in shape with a tapered bottom 884 and a neck/shoulder 882 connecting to rod 850. The transverse size (e.g., diameter) 980D of crystal boule 880 may be in the range between 3 and 35 centimeters (cm), and its height 980H may be in the range between 2 and 45 cm (not including the neck/shoulder and tapered bottom portions).

Referring again to FIG. 7, after removal of the crystal boule from the melt, method 700 cools the crystal boule from above to below the Curie temperature in an isothermal environment (step 740). In a conventional process, the crystal boule is subjected to an external electric field during cooling, whereby the entire volume of the crystal boule attains the same polarization direction. Isothermal cooling step 740, on the other hand, does not apply an external electric field of sufficient strength to pole the crystal boule. In one embodiment, no external electric field is applied during isothermal cooling step 740. Additionally, the isothermal environment ensures that the entire volume of the crystal boule undergoes the ferroelectric phase transition at approximately the same time. Each local region of the crystal boule therefore has no preference imposed thereon for a particular one of the two possible polarization directions. Consequently, each local region attains a random one of the two possible polarizations. In a cross section of the crystal boule taken orthogonally to one of the crystal axes, the resulting domain structure may resemble that shown in FIG. 3 or FIG. 4 depending on the orientation of the cross section.

FIG. 10 illustrates one embodiment of isothermal cooling step 740 of method 700, wherein isothermal cooling step 740 is performed in the same furnace as crystal growth step 710 of method 700. In this embodiment, crystal boule 880 is situated above melt 820 in furnace 800, and heating elements 840 are adjusted such that the environment surrounding crystal boule 880 is approximately isothermal, as indicated by temperature profile 990. In an alternative embodiment, isothermal cooling step 740 is performed in a different furnace.

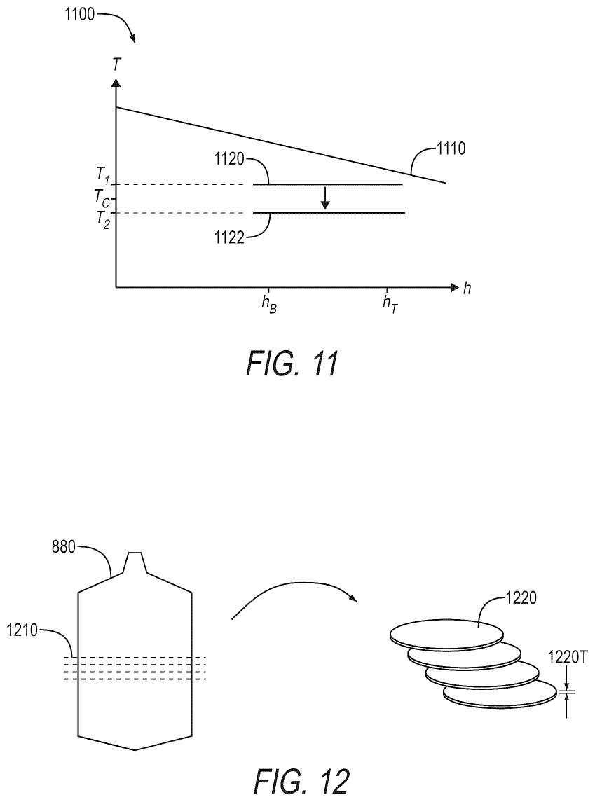

FIG. 11 is a plot 1100 of exemplary temperature profiles during crystal growth step 710 and isothermal cooling step 740 of method 700. During crystal growth step 710, the temperature decreases as a function of height h above the melt, as schematically indicated by temperature profile 1110. For isothermal cooling step 740, the crystal boule is positioned in an isothermal environment. At the beginning of isothermal cooling step 740, the isothermal environment has a temperature T_1 that exceeds the Curie temperature T_C. This is indicated by temperature profile 1120 that is uniform and above the Curie temperature at least over the range from the height of the crystal boule top, h_T, to the height of the crystal boule bottom, h_B. Isothermal cooling step 740 entails lowering the temperature of the isothermal environment from T_1 to a temperature T_2 that is below the Curie temperature, as indicated by temperature profile 1122.

In one example, T_1 exceeds T_C by at least 10 degrees Celsius, and T_2 is at least 10 degrees Celsius less than T_C. The Curie temperature depends on the exact composition of the lithium niobate crystal. For example, the Curie temperature may be in the range between 1200 and 1230 degrees Celsius for sLiNbO3 and doped versions thereof, while csLiNbO3 may have a Curie temperature in the range between 1030 and 1045 degrees Celsius. The rate at which the temperature of the isothermal environment is lowered depends on the size of the crystal boule. Preferably, the rate of temperature reduction of the isothermal environment is sufficiently slow to allow thermal equilibration of the volume of the crystal boule. This allows for maintaining an approximately uniform temperature of the crystal boule, whereby the full volume of the crystal boule undergoes the phase transition at approximately the same time. In one example, the temperature of the isothermal environment is lowered at a rate of no more than 2.5 degrees Celsius per hour.

Without departing from the scope hereof, the isothermal environment in isothermal cooling step 740 may exhibit some temperature non-uniformity. However, to ensure the formation of many ferroelectric domains, the maximum temperature gradient for the isothermal environment may be 0.5 degrees Celsius/cm, and/or the maximum temperature difference between locations within the crystal boule itself may be 2 degrees Celsius. At the same time, the maximum electric field at the location of the crystal boule may be less than 100 or 50 volts/cm.

When furnace 800 is used for both crystal growth step 710 and isothermal cooling step 740, furnace 800 may include two or more heating elements 840 in order to tailor the thermal environment as needed for each of these two steps of method 700. For example, furnace 800 may include between four and eight heating elements 840.

Referring again to FIG. 7, when the same furnace is used for both crystal growth step 710 and isothermal cooling step 740, the crystal boule may remain in the growth furnace from completion of crystal growth step 710 to completion of isothermal cooling step 740. However, it is also possible to remove the crystal boule from the growth furnace between crystal growth step 710 and isothermal cooling step 740. In such cases, isothermal cooling step 740 may be performed either in the growth furnace at a later time or in a different furnace. If the temperature of some or all of the crystal boule is allowed to drop below the Curie temperature before isothermal cooling step 740, method 700 may further include heating the crystal boule to above the Curie temperature (step 730).

Optionally, method 700 includes cutting the multi-domain crystal boule into a plurality of multi-domain lithium niobate wafers (step 750). Individual multi-domain lithium niobate waveguides 210 may then be produced from such wafers by, e.g., dicing and polishing.

In a modification of method 700, step 720 is omitted and isothermal cooling step 740 is instead performed while a bottom portion of the crystal boule is still in contact with the melt. Provided that the contact area between the crystal boule and the melt is small, the temperature of the crystal boule may still be sufficiently uniform that at least a majority of the crystal boule (e.g., all but a tapered bottom of the crystal boule) undergoes the phase transition at the same time.

FIG. 12 illustrates one example of cutting step 750, wherein crystal boule 880 is cut orthogonally to its growth direction, as indicated by cutting lines 1210, to produce a plurality of multi-domain lithium niobate wafers 1220. In a typical embodiment, the number of wafers 1220 produced in this manner is much larger than the four shown in FIG. 12. The thickness 1220T of each wafer 1220 may be in the range between 0.25 and 2.5 mm.

Method 700 is compatible with growing the crystal boule along any one of the crystal axes. In one embodiment, the crystal boule is z-axis grown, that is, the thermal gradient is along the z-axis of crystal boule 860. From a thermal perspective, z-axis growth is advantageous over x- and y-axis growth. The thermal expansion coefficients along the x- and y-axes of a lithium niobate crystal are relatively similar to each other but significantly different from the thermal expansion coefficient along the z-axis. When the crystal boule is grown along its z-axis, the thermal expansion coefficients in the horizontal plane are very similar. In contrast, when the crystal boule is grown along its x- or y-axis, one horizontally oriented crystal axis has significantly different thermal expansion coefficient than the orthogonal, horizontally oriented crystal axis. Extra attention to the thermal management of the crystal boule during growth and cooling to room temperature may therefore be performed in order to prevent the x- or y-axis grown crystal boule from cracking.

When cutting the multi-domain crystal boule produced by method 700 into wafers, the best material utilization may be achieved when the crystal boule is cut orthogonally to its growth axis, as shown in FIG. 12. Thus, in one embodiment, method 700 grows the crystal boule along its z-axis, and the crystal boule is z-cut in cutting step 750. Waveguides 300 may be produced from such wafers. In another embodiment, method 700 grows the crystal boule along its x-axis (or, alternatively, y-axis), and the crystal boule is x-cut (or, alternatively, y-cut) in cutting step 750. Waveguides 400 may be produced from these wafers.

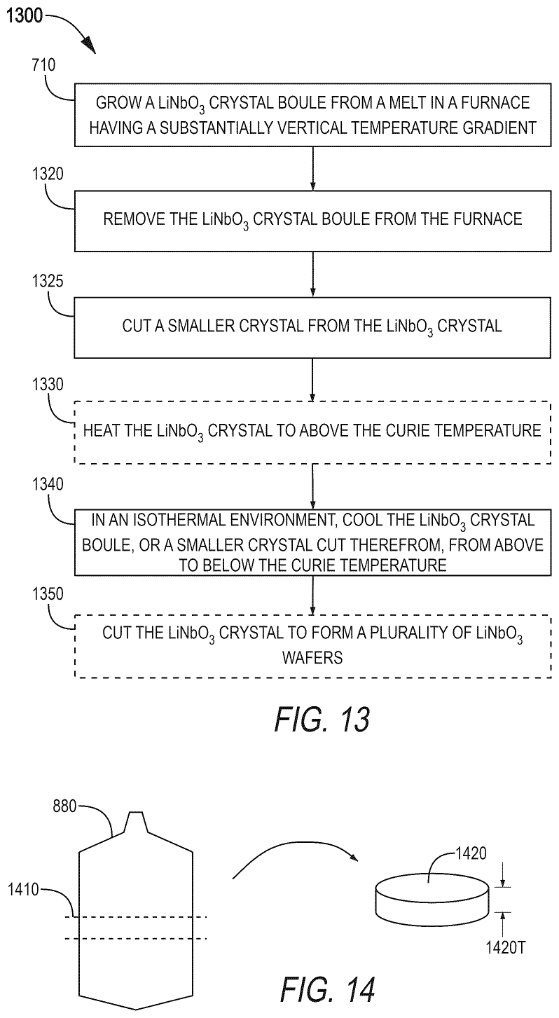

FIG. 13 is a flowchart for one method 1300 for manufacturing a multi-domain lithium niobate crystal, wherein the crystal is cut from a lithium niobate crystal boule and the multi-domain structure is promoted during cooling of the cut crystal in an isothermal environment. Methods 1300 and 700 differ from each other in that method 700 applies the isothermal cooling step to the entire crystal boule, whereas method 1300 applies the isothermal cooling step to a smaller crystal cut from the crystal boule.

Method 1300 initially performs crystal growth step 710, as discussed above. After removing the crystal boule from the furnace (step 1320) and before isothermal cooling to promote many ferroelectric domains (step 1340), a smaller crystal is cut from the crystal boule (step 1325).

FIG. 14 illustrates one example of cutting step 1325. In this example, crystal boule 880 is cut along two cutting lines 1410, orthogonally to the growth axis of crystal boule 880, to produce a smaller crystal 1420. The thickness 1420T of crystal 1420 may be anywhere in the range from wafer thickness 1220T (see FIG. 12) to height 980H (see FIG. 9).

Referring again to FIG. 13, method 1300 applies an isothermal cooling step 1340 to the smaller crystal cut from the crystal boule in cutting step 1325. Isothermal cooling step 1340 is similar to isothermal cooling step 740 of method 700, except for being applied to a smaller crystal cut from the crystal boule and possibly using a more rapid cooling rate. Applying isothermal cooling step 1340 to a smaller crystal, rather than the entire crystal boule, may allow for a more rapid cooling rate while maintaining sufficient temperature uniformity of the crystal itself to promote many ferroelectric domains. A more rapid cooling rate may lead to a substantial reduction in overall processing time for method 1300, as compared to method 700. For example, when isothermal cooling step 1340 is applied to a wafer, such as wafer 1220, the cooling rate may exceed 2.5 degrees Celsius per hour. Applying isothermal cooling step 1340 to a smaller crystal may also allow for using a smaller furnace. For example, a furnace may be sized to accommodate one or a few wafers 1220. Optionally, such wafers may be transported through the furnace by a conveyor belt.

Similar to isothermal cooling step 740 of the crystal boule in method 700, the isothermal environment in isothermal cooling step 740 may exhibit some temperature non-uniformity. To ensure the formation of many ferroelectric domains, the maximum temperature gradient for the isothermal environment may be 0.5 degrees Celsius/cm, and/or the maximum temperature difference between locations within the crystal boule itself may be 2 degrees Celsius. At the same time, the maximum electric field at the location of the crystal boule may be less than 100 or 50 volts/cm.

In most scenarios, the temperature of the crystal boule has dropped below the Curie temperature before performing cutting step 1325 or at least before performing isothermal cooling step 1340. Therefore, prior to performing isothermal cooling step 1340, method 1300 may heat the smaller crystal to above the Curie temperature (step 1330) so as to enable isothermal cooling through the Curie temperature. Heating step 1330 typically takes place in the same furnace as isothermal cooling step 1340.

When the smaller crystal formed in cutting step 1325 is larger than a wafer, method 1300 may further include cutting the crystal to produce a plurality of wafers (step 1350), for example to produce wafers 1220 (see FIG. 12).

Without departing from the scope hereof, cutting step 1325 may produce a plurality of smaller crystals, e.g., a plurality of boule segments 1420 and/or wafers 1220. The remainder of method 1300 may be applied to each of these smaller crystals, in series or in parallel.

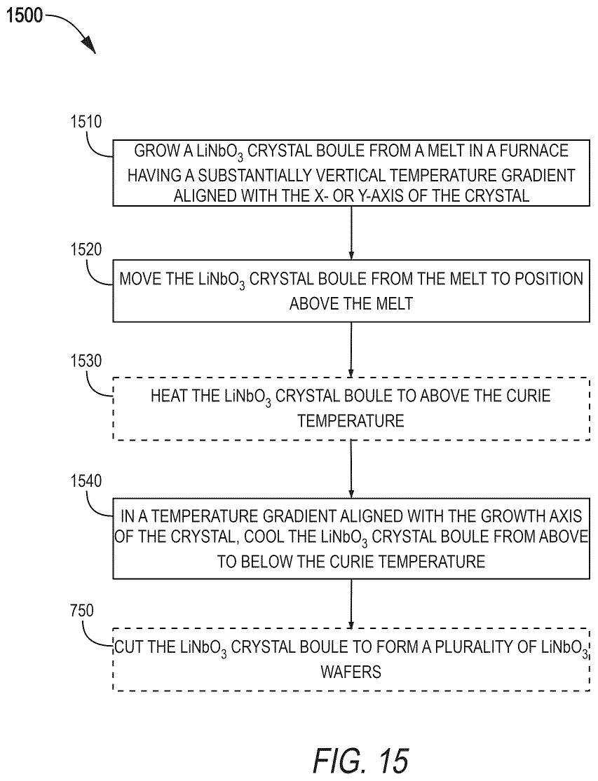

FIG. 15 is a flowchart for one method 1500 for manufacturing a multi-domain lithium niobate crystal boule, wherein (a) the crystal boule is x- or y-axis grown and (b) multi-domain structure is promoted during cooling of the lithium niobate crystal boule in the growth furnace in a temperature gradient that is aligned with the growth axis. Growing the crystal boule along the x- or y-axis may present challenges relating to thermal expansion, as discussed above. However, unlike method 700, method 1500 does not rely on maintaining an approximately uniform temperature of the crystal boule during cooling through the Curie temperature. Instead, method 1500 grows the crystal boule and forms the multi-domain structure in similarly shaped temperature profiles.

The multi-domain lithium niobate crystal boule manufactured by method 1500 may be cut and/or otherwise machined to produce certain embodiments of waveguide 210 of display device 200, for example either one of waveguides 300 and 400. For optimal utilization of the material of the crystal boule, the crystal boule may be cut orthogonally to the growth axis to produce a plurality of wafers. A plurality of waveguides 400 may be produced from these wafers.

Method 1500 grows a lithium niobate crystal boule from a melt in a furnace (step 1510). The growth process utilizes a temperature gradient, wherein the temperature decreases as a function of distance above the melt. Crystal growth step 1510 is similar to crystal growth step 710 of method 700 except that crystal growth step 1510 specifically involves the x- or y-axis of the crystal being aligned with the temperature gradient, whereby the crystal is grown along the x- or y-axis. After moving the crystal boule from the melt to a position above the melt (step 1520), method 1500 cools the crystal boule from above to below the Curie temperature in a temperature gradient that is aligned with the growth axis of the crystal boule (step 1540) in order to promote many ferroelectric domains therein.

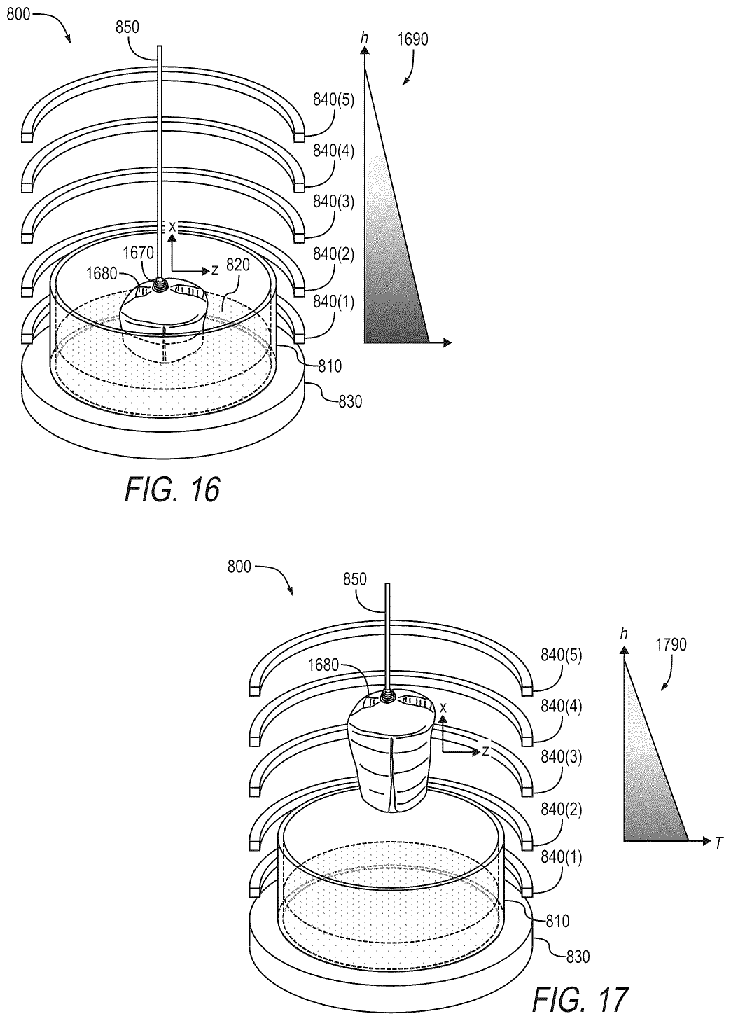

FIG. 16 illustrates one embodiment of crystal growth step 1510 of method 1500 utilizing the Czochralski growth process. In this embodiment, a lithium niobate crystal boule 1680 is x-axis grown from melt 820 in furnace 800. Heating elements 840 are adjusted to generate a vertical temperature gradient 1690. Vertical temperature gradient 1690 may be similar to vertical temperature gradient 890 (see FIG. 8) used in one embodiment of method 700. Growth of crystal boule 1680 is initiated at a seed crystal 1670 attached to rod 850. The x-axis of seed crystal 1670 is oriented vertically.

Referring again to FIG. 15, crystal boules grown in crystal growth step 1510 may have dimensions and shapes similar to those discussed above for crystal boule 880 of FIG. 8.

After moving the crystal boule from the melt to a position above the melt, method 1500 cools the crystal boule from above to below the Curie temperature in another temperature gradient aligned with the growth axis of the crystal boule. For reasons similar to those discussed above in reference to isothermal cooling step 740 of method 700, gradient cooling step 1540 does not apply an external electric field of sufficient strength to pole the crystal boule. In one embodiment, no external electric field is applied during gradient cooling step 1540.

FIG. 17 illustrates one embodiment of gradient cooling step 1540 of method 1500. In this embodiment, crystal boule 1680 is situated above melt 820 in furnace 800, and heating elements 840 are adjusted to produce a vertical temperature gradient 1790 aligned with the x-axis of crystal boule 1680. Vertical temperature gradient 1790 may be similar to vertical temperature gradient 1690 apart from being shifted to lower temperatures.

In another implementation of method 1500, crystal boule 1680 is y-axis grown, and temperature gradient 1690 is along the y-axis of crystal boule 1680. This implementation is similar to the embodiments shown in FIGS. 15 and 16 except that the y-axis is aligned with the temperature gradient.

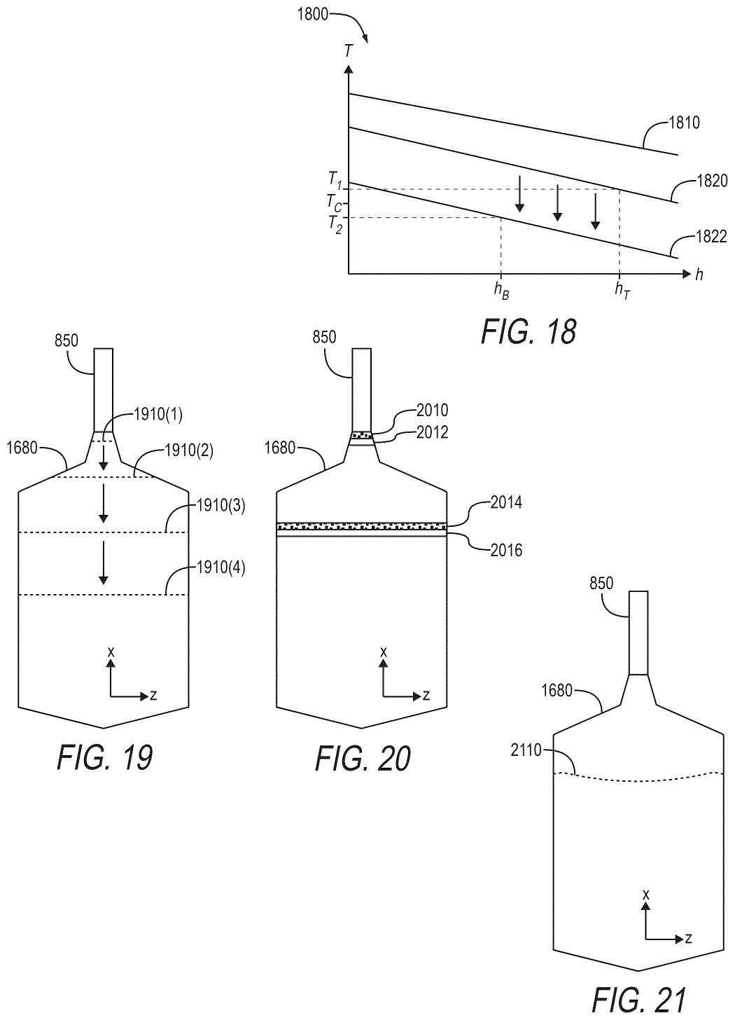

FIG. 18 is a plot 1800 of exemplary temperature profiles during crystal growth step 1510 and gradient cooling step 1540 of method 1500. During crystal growth step 1510, the temperature decreases as a function of height h above the melt, as schematically indicated by temperature profile 1810. In gradient cooling step 1540, the crystal boule is positioned above the melt in a vertical temperature gradient, such that the temperature decreases as a function of height h above the melt also during this step. However, the general temperature at the location of the crystal boule may be lower during gradient cooling step 1540 than during crystal growth step 1510.

Plot 1800 indicates the top h_T and bottom h_B of the crystal boule during gradient cooling step 1540. At the beginning of gradient cooling step 1540, the thermal environment is characterized by a vertical temperature gradient indicated by temperature profile 1820. With this initial vertical temperature gradient, the entire crystal boule is subjected to a temperature that exceeds the Curie temperature T_C. The coolest temperature is at the top h_T of the crystal, where the temperature is T_1. Temperature T_1 is discussed above in reference to method 700 and FIG. 11 and exceeds the Curie temperature by some amount. During gradient cooling step 1540, the vertical temperature gradient is shifted to a lower temperature, at least until the temperature at the bottom h_B of the crystal boule is less than the Curie temperature. At this point in time, the temperature at the bottom h_B of the crystal boule, the hottest location, is T_2. As discussed above in reference to method 700 and FIG. 11, temperature T_2 is somewhat lower than the Curie temperature.

Without departing from the scope hereof, one or more of temperature profiles 1810, 1820, and 1822 may deviate from linearity. In addition, the shape or slope of the temperature gradient indicated by temperature profile 1822 may differ from that of the temperature gradient indicated by temperature profile 1820.

In a generalization of plot 1800, temperature gradient is not exactly vertical but rather sufficiently vertical to practically contain the melt during crystal growth. Additionally, the temperature gradient applied during gradient cooling does not need to be vertical. More generally, the temperature gradient applied during gradient cooling is orthogonal to the z-axis.

FIG. 19 is a schematic diagram of crystal boule 1680 showing exemplary isotherms 1910 during gradient cooling step 1540 of method 1500. Each isotherm 1910 indicates a plane in crystal boule 1680 that is at the Curie temperature at a particular time during gradient cooling step 1540. At a time early on in gradient cooling step 1540, the majority of crystal boule 1680 is hotter than the Curie temperature, and the plane characterized by the Curie temperature is near the very top of crystal boule 1680, as indicated by isotherm 1910 (1). As gradient cooling step 1540 progresses, the isotherm characterized by the Curie temperature shifts to lower and lower positions, as indicated by the series of isotherms 1910 (2-4). At any given time, the portion of crystal boule 1680 that is above the corresponding isotherm 1910 is cooler than the Curie temperature, and the portion of crystal boule 1680 that is below the corresponding isotherm 1910 is still warmer than the Curie temperature. In short, at any given time during gradient cooling step 1540, a single horizontal slice of crystal boule 1680 is in the process of undergoing the phase transition.

FIG. 20 is a related schematic diagram of crystal boule 1680 showing exemplary horizontal slices of crystal boule 1680 undergoing the phase transition. The first slice to undergo the phase transition is the top-most slice 2010. With no external poling applied, each local region of slice 2010 gets a random one of the two possible polarizations. This leads to the formation of many ferroelectric domains, each horizontally polarized. The domain structure of slice 2010 may be similar to that shown in FIG. 4. Next, an adjacent horizontal slice 2012 undergoes the phase transition. Again, there is no external poling applied. In addition, any local electric fields generated by the already formed ferroelectric domains of slice 2010 are horizontal, small, and randomly flip between two opposite horizontal directions. Thus, slice 2010 also does not impose a poling electric field on slice 2012. Therefore, each local region of slice 2012 gets a random one of the two possible horizontal polarization. This sequence of events continues (see, e.g., slices 2014 and 2016) until every horizontal slice of crystal boule 1680 has undergone the phase transition to form many randomly distributed ferroelectric domains, each horizontally polarized.

The discussion of FIGS. 19 and 20 assumes that each isotherm 1910 is a horizontal plane. In practice, isotherms are generally horizontal but deviations from exact planarity are likely to occur.

FIG. 21 is a related schematic diagram of crystal boule 1680 showing an exemplary bowl-shaped isotherm 2110. In this example, rod 850 functions as a heat sink, which leads to the center axis of crystal boule 1680 being slightly cooler than more radially-outward locations. Also, since the surface of crystal boule 1680 is in direct contact with the cooling thermal environment, the surface of crystal boule 1680 is slightly cooler than interior locations. Isotherm 2110 is therefore slightly bowl-shaped with an additional dip at the edges.

Even with deviations from perfect planarity of the isotherms, such as shown in FIG. 21, a slice that has already undergone the phase transition is unlikely to pole the subsequent slice. The reasons are (a) the slices are still mostly horizontal and (b) any local electric fields generated by the already formed ferroelectric domains are horizontal, small, and random.

Referring again to FIG. 15, method 1500 may further include a heating step 1530 in the event that some or all of the crystal boule drops below the Curie temperature before establishing the proper temperature gradient for gradient cooling step 1540. Method 1500 may also include cutting step 750, discussed above in reference to FIG. 7.

In a modification of method 1500, step 1520 is omitted and gradient cooling step 1540 is instead performed while a bottom portion of the crystal boule is still in contact with the melt. In this scenario, gradient cooling step 1540 may be initiated before completion of crystal growth step 1510. For example, the top of the crystal boule may begin to undergo gradient cooling step 1540 before the crystal boule is grown to its final size.

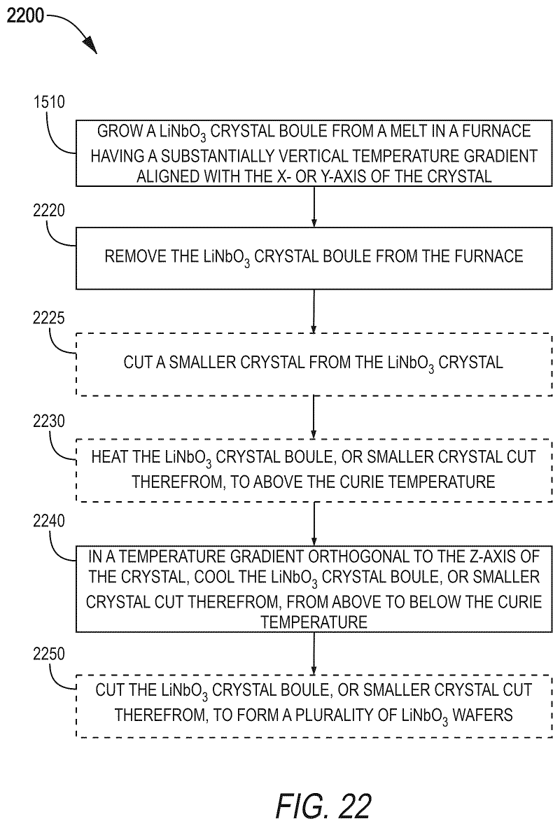

FIG. 22 is a flowchart for one method 2200 for manufacturing a multi-domain lithium niobate crystal boule, wherein the crystal boule is x- or y-axis grown and multi-domain structure is promoted during cooling of the lithium niobate crystal boule in a temperature gradient that is orthogonal to the z-axis. Method 2200 first performs crystal growth step 1510 as discussed above in reference to FIG. 15. After removing the crystal boule from the melt and from the furnace (step 2220), method 2200 cools the crystal boule, or a smaller crystal cut therefrom, from above to below the Curie temperature in a temperature gradient that is orthogonal to the z-axis (step 2240) in order to promote many ferroelectric domains therein.

Gradient cooling step 2240 of method 2200 relies on the same mechanism as gradient cooling step 1540 of method 1500 for promoting the multi-domain configuration, and method 2200 may serve to produce the same multi-domain lithium niobate waveguides as method 1500. However, unlike method 1500, method 2100 does not involve the temperature gradient in the gradient cooling step being aligned with the growth axis. In method 2100, the crystal boule is removed from the growth furnace. Method 2100 thus allows for cooling the crystal boule (or a smaller crystal cut therefrom) through the Curie temperature in a temperature gradient that is aligned with any direction in the xy-plane of the crystal boule. This is sufficient to facilitate the multi-domain formation process discussed above in reference to FIGS. 18-21.

Gradient cooling step 2240 is typically performed in a different furnace than the growth furnace. As alluded to above, method 2200 may include cutting a smaller crystal from the crystal boule (step 2225) and applying gradient cooling step 2240 to this smaller crystal. Cutting step 2225 is similar to cutting step 1325 of method 1300 and may produce, e.g., a plurality of wafers 1220 (see FIG. 12) or boule segments 1420 (see FIG. 14). Without departing from the scope hereof, the remainder of method 2200 may be applied to each of several smaller crystals cut from the crystal boule in step 2225. For optimal material utilization, cutting step 2225 may cut the crystal boule orthogonally to its growth axis, in which case any wafers produced by cutting step 2225 are parallel to the z-axis.

In most scenarios, the temperature of the crystal boule, or smaller crystal cut therefrom, has dropped below the Curie temperature before performing gradient cooling step 2240. Therefore, gradient cooling step 2240 may be preceded by heating the crystal boule, or smaller crystal cut therefrom, to above the Curie temperature (step 2230). Heating step 2230 is similar to heating step 1330 of method 1300 and may take place in the same furnace as gradient cooling step 2240.

In embodiments where the crystal boule is not cut into wafers prior to gradient cooling step 2240, method 2200 may produce such wafers by cutting (step 2250) after gradient cooling step 2240.

In a modification of method 2200, step 2220 is omitted such that the crystal boule is kept in the growth furnace through completion of gradient cooling step 2240, and the temperature gradient in gradient cooling step 2240 is not aligned with the growth axis of the crystal boule. In this modified version of method 2200, the crystal boule may be reoriented in the growth furnace before gradient cooling step 2240. Alternatively, the growth furnace may be equipped with heating elements that can produce temperature gradients in at least two different directions. This modified version of method 2200 may impose practical complications not present when the temperature gradients of crystal growth step 1510 and gradient cooling step 2240 are aligned with same crystal axis.

Without departing from the scope hereof, gradient cooling step 2240 may be applied to a z-axis grown crystal boule, or a smaller crystal cut therefrom, to produce a multi-domain crystal boule or crystal.

As discussed above in reference to FIGS. 3 and 4, it may be preferable that the multi-domain lithium niobate waveguide, produced using any one of the methods discussed herein, is characterized by approximately equal prevalence of the two opposite polarizations in terms of volume. It may be possible to actively promote such equal prevalence by applying an external electric field during the cooling process that forms the multi-domain configuration. This external electric field may be weaker than the external electric field applied in conventional poling processes serving to form a single-domain lithium niobate crystal, yet strong enough to affect the relative prevalence of the two different polarizations. In one example, this external electric field is in the range between 5 and 150 volts/cm. This external electric field can be applied at a value remaining constant over time or in periodic manner, so that the field is on for a certain duration (typically a few seconds) and off for another duration (typically between 5 and 30 seconds). One practical implementation of this approach is discussed in the following within the context of method 1500.

In another modification of method 2200, step 1510 instead grows the lithium niobate crystal boule along the z-axis, step 2225 cuts one or more z-axis-cut wafers from the z-axis grown lithium niobate crystal boule, and step 2240 is applied to each of these wafers.

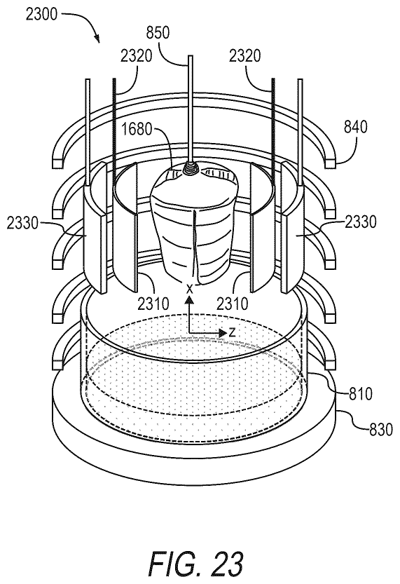

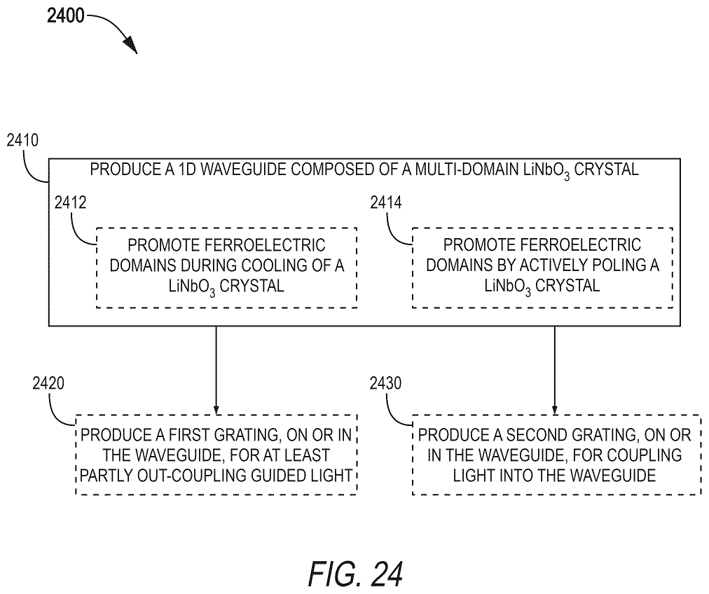

FIG. 23 illustrates one crystal growth furnace 2300 configured to electrically manipulate x-axis grown crystal boule 1680 during the cooling process that promotes the multi-domain configuration in method 1500. Furnace 2300 is an embodiment of furnace 800 (see FIG. 8) that further includes a pair of electrodes 2310. During gradient cooling step 1540, electrodes 2310 may be pressed against two sides of crystal boule 1680 that are at opposite z-axis extremes. A suitable electric field may be applied via electrical connections 2320 to promote a desired prevalence ratio between the two polarizations. Electrodes 2310 may be metal foils, in which case furnace 2300 may further include more rigid clamping elements 2330 that can press electrodes 2310 against crystal boule 1680.

The system shown in FIG. 23 may be applied to y-axis grown crystal boules as well. Additionally, a similar electrode configuration may be implemented in a separate furnace dedicated to the gradient cooling or isothermal cooling processes discussed above.

FIG. 24 is a flowchart for one method 2400 for manufacturing a see-through near-eye display device with a multi-domain lithium niobate waveguide. Method 2400 produces a one-dimensional waveguide composed of multi-domain lithium niobate (step 2410). The production of this waveguide may include promoting many ferroelectric domains in a lithium niobate crystal during cooling of the lithium niobate crystal through the Curie temperature (step 2412). Several examples of this process are discussed above, see isothermal cooling steps 740 (FIG. 7) and 1340 (FIG. 13) and gradient cooling steps 1540 (FIG. 15) and 2240 (FIG. 22). Alternatively, the waveguide production may include promoting multiple ferroelectric domains in a lithium niobate crystal by actively poling the lithium niobate crystal (step 2414). Either way, method 2400 may further include producing (a) a grating in or on the multi-domain lithium niobate waveguide for at least partly out-coupling light guided therein (step 2420) and/or (b) a grating in or on the multi-domain lithium niobate waveguide for coupling light into the waveguide (step 2430).

While the present method and/or system has been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. Therefore, it is intended that the present method and/or system not be limited to the particular implementations disclosed, but that the present method and/or system will include all implementations falling within the scope of the appended claims.

What is claimed is:

1. A see-through near-eye display device, comprising:
an image source configured to emit light conveying an image;
a waveguide comprising a multi-domain lithium niobate crystal, wherein:
the waveguide is a one-dimensional waveguide,
the waveguide is configured to receive and guide the light emitted by the image source,
the multi-domain lithium niobate crystal comprises a plurality of ferroelectric domains,
each ferroelectric domain is polarized along a z-axis of the lithium niobate crystal,
each ferroelectric domain has a polarization direction opposite the polarization direction of an adjacent ferroelectric domain, and
the multi-domain lithium niobate crystal is a single crystal; and
a grating disposed on or in the waveguide, wherein the grating is configured to couple, out of the waveguide, at least a portion of the light, from the image source, after having been guided by the waveguide to the grating.

2. The device of claim 1, wherein the ferroelectric domains are distributed randomly.

3. The device of claim 1, wherein a shortest distance, parallel to the waveguide, from a location within the waveguide to an oppositely-polarized ferroelectric domain is, on average, less than 500 micrometers.

4. The device of claim 1, wherein the waveguide has a thickness in the range between 0.25 and 2.5 millimeters.

5. The device of claim 1, wherein the waveguide has first and second surfaces facing away from each other, and total internal reflection of the light at the first and second surfaces results in one-dimensional waveguiding of the light.

6. A method for manufacturing a multi-domain lithium niobate crystal, comprising steps of:
growing a lithium niobate crystal boule from a melt in a furnace having a temperature gradient; and
in an isothermal environment, cooling a lithium niobate crystal, in the form of the lithium niobate crystal boule or a smaller crystal cut therefrom, from above to below a Curie temperature of the lithium niobate crystal to form multiple ferroelectric domains, wherein each ferroelectric domain is polarized along the z-axis and has a polarization direction opposite the polarization direction of an adjacent ferroelectric domain.

7. The method of claim 6, wherein a z-axis of the lithium niobate crystal boule is aligned with the temperature gradient during the step of growing.

8. The method of claim 6, wherein the ferroelectric domains are distributed randomly.

9. The method of claim 6, wherein, after the step of cooling, a shortest distance from a location within the lithium niobate crystal to an oppositely-polarized ferroelectric domain is, on average, less than 500 micrometers.

10. The method of claim 6, wherein the step of cooling is performed without subjecting the lithium niobate crystal to an external electric field of sufficient strength to pole the lithium niobate crystal.

11. The method of claim 6, wherein the isothermal environment is characterized by a maximum temperature gradient of at most 0.5 degrees Celsius per centimeter, and further characterized by a maximum electric field of at most 50 volts per centimeter.

12. The method of claim 6, wherein a maximum temperature difference within the lithium niobate crystal is at most 2 degrees Celsius during the step of cooling.

13. The method of claim 6, wherein the method comprises a step of removing the lithium niobate crystal boule from the melt between the steps of growing and cooling.

14. The method of claim 13, wherein the method comprises, after the step of removing and before the step of cooling, heating the lithium niobate crystal to above the Curie temperature.

15. The method of claim 6, wherein the step of cooling comprises cooling the lithium niobate crystal from at least 10 degrees Celsius above the Curie temperature to at least 10 degrees below the Curie temperature.

16. The method of claim 6, wherein the step of cooling is applied to the lithium niobate crystal boule in the furnace at a position above the melt.

17. The method of claim 6, wherein the method comprises cutting the lithium niobate crystal to form a plurality of lithium niobate wafers.

18. The method of claim 17, wherein the step of cutting is applied to the lithium niobate crystal boule before the step of cooling, and each of the lithium niobate wafers is subjected to the step of cooling.

19. The method of claim 18, wherein:
the step of cutting the lithium niobate crystal boule takes place outside the furnace;
the step of cooling takes place in a second furnace; and
the method comprises, for each of the lithium niobate wafers, heating the lithium niobate wafer to above the Curie temperature in the second furnace before subjecting the lithium niobate wafer to the step of cooling.

20. The method of claim 17, wherein the method comprises:
producing a smaller lithium niobate substrate from one of the lithium niobate wafers; and
implementing the smaller lithium niobate substrate as a one-dimensional waveguide in a see-through near-eye display device.
